(19) United States
(12) Patent Application Publication
(10) Pub. No.: US 2006/0290978 A1
(43) Pub. Date: Dec. 28, 2006

(54) Dynamic workspace for organizing digital content

(76) Inventors: Blake Springer, Calgary (CA); Sheldon Maloff, Bragg Creek (CA)

Correspondence Address: Craig K. Sherburne, #236, 6030 - 88 Street, Edmonton, AB, T6E 6G4, CA

(21) Appl. No.: 11/432,618

(22) Filed: May 12, 2006

Related U.S. Application Data
(60) Provisional application No. 60/680,508, filed on May 13, 2005.

(51) Int. Cl. G06F 3/12

(52) U.S. Cl. 358/1.15; 358/448

(57) ABSTRACT

A computer-based method and system for organizing, modifying, viewing, annotating and sharing digital content items. In a preferred embodiment, a modifiable dynamic workspace displays digital content items which are low resolution proxies of high resolution digital content items. In one embodiment the workspace provides the user the ability to organize, resize, crop, annotate and share the low resolution proxies without direct access to the high resolution versions of these digital content items. In another embodiment, the items displayed in the workspace are the identical copies of the high resolution digital content items.

### RELATED APPLICATION

This application claims the benefit of U.S. Provisional Application Ser. No. 60/680,508 filed May 13, 2005, under 35 U.S.C. 119(e). The entire disclosure of the prior application is hereby incorporated by reference.

### FIELD OF THE INVENTION

The present invention relates to systems and methods for organizing, modifying, viewing, manipulating and sharing digital content items.

### BACKGROUND OF THE INVENTION

Creative professionals use digital content in their creative process. Digital content includes items such as photography, typography, illustration, video, and audio. The creative process typically involves a number of steps where the creative professional must find, select, purchase, and integrate different types of digital content into their work. The work that results from this process includes, but is not limited to, printed publications, electronic publications (documents, web pages, etc.), and video content.

The process of finding, selecting, purchasing, and delivering content is typically done online via electronic commerce web sites.

Creative professionals, or other individuals working on their behalf, typically start by searching for content by entering search terms into an online search engine and are presented with a large number of digital content items. Then, from this large set, they will select a subset of the digital content items as candidates for usage in their work. The process of searching may involve many individual searches and the selection of a large number of candidate digital content items.

Once they have a sufficient selection of potential digital content items, they will further reduce their selection and may consult others (the party which hired them, their peers, etc.), to finalize their choices. Using the means available in the prior art, at this point the creative professional may download low resolution (or compositing versions) of their selections and combine them into their work in order to visualize their final usage, but such a process is performed independent of the digital content provider and can be time consuming, complex and problematic for the user. Digital content items are often altered as part of the process; they may be resized, cropped, combined with other elements, colours changed, etc.

Once they have decided which specific digital content items they are going to purchase they will go through an e-commerce purchase process and at the end of the process they will be able to download the full version of the digital content items to their computer to use in their work.

In the past, the problems solved by the present invention were inadequately addressed with online “lightboxes”. A typical lightbox solution provides the user with a static grid into which they can add digital content item (DCIs). The grid is static from the perspective that it does not allow for freeform organization of the DCIs relative to one another. The location and size of the DCIs is predetermined and the user has no ability to change the order, size, or position of the DCIs. Unlike the present invention, the lightbox solution does not allow the user to visualize the DCIs in a way which reflects their potential usage.

### SUMMARY OF THE INVENTION

The present invention comprises a computer-based method and system for organizing, modifying, viewing, annotating and sharing digital content items. In a preferred embodiment, a modifiable dynamic workspace displays digital content items which are low resolution proxies of high resolution digital content items. In one embodiment the workspace provides the user the ability to organize, resize, crop, annotate and share the low resolution proxies without direct access to the high resolution versions of these digital content items. In another embodiment, the items displayed in the workspace are the identical copies of the high resolution digital content items.

As shown in the drawings and accompanying description, the present invention provides methods and systems for creating and maintaining a plurality of dynamic workspaces for organizing digital content (DWODCs). Each DWODC is an arbitrarily large three dimensional space presented in the two dimensional environment of the computer screen. A DWODC may contain multiple digital content items (DCI). A digital content item is a resource that can be electronically stored and contains a type of image, sound, video, typeface, text, etc. One skilled in the art will recognize that DCIs may include various forms of digital media, or digital representations of original work, not directly mentioned above. The term “digital content item” is intended to encompass all forms of digital media, including those not specifically mentioned. A DCI may also be a proxy representation of the original resource. For example, a DCI may be a low resolution version of a high resolution digital photograph; a low-resolution representation of a movie or audio file, a portion or representative sample of a movie or audio segment, etc. In this case, the DCI acts as a proxy for the original resource. This is useful in instances when the original resource is an item offered for sale or license, and the seller wishes to protect their digital resource while at the same time provide access to a version of the resource to facilitate the decision making process leading to a potential purchase or licensing decision.

The DWODC client application provides the user interface through which the workspace can be managed.

In one aspect, the present invention provides a system for addressing the existing limitations of the previewing prior to purchase of DCIs through the use of a DWODC; enabling the modification, arrangement and ordering of DCIs. In a preferred embodiment, the purchaser of the DCI is located at a remote purchase location and communicates with the supplier through a computer system transmitting data through a computer network interface to a pre-programmed main computer of the DCI supplier, using a communications network such as the global Internet or other electronic network. Using the DWODC the potential purchaser of DCIs is able to select for inclusion in the DWODC individual DCIs from a catalogue or other listing of available DCI content, as well as upload into the DWODC DCIs from the purchaser's computer system or a third party computer system. Once included in the DWODC the purchaser may manipulate, organize and arrange the DCI in the workspace with the ability to modify the DCIs. Non-limiting examples of DCI manipulation, in the context of images and video include non-linear or linear cropping, resizing, altering the transparency, rotating, scaled cropping, addition of type elements, skewing, flipping, stretching or re-coloring. Non-limiting examples of DCI manipulation, in the context of video and audio include changing the quality of playback, altering the duration, start and end of the audio or video element.

A number of other functions are contemplated to be usable in the DWODC. One non-limiting example is the inclusion of warnings or error messages provided to the user if the DCI is manipulated in a way which could result in poor production quality. This could arise where the image is resized, cropped or otherwise modified in the DWODC such that printing or reproduction of the DCI beyond a certain size may result in poor or otherwise unacceptable resolution.

Furthermore, the present invention contemplates the ability to introduce into the DWODC a user-provided template for to assist the user in organization, modification and arrangement of the DCIs. The user provided template can either exist as a graphic existing as a bottom-layer within a multi-layered DWODC environment, a graphic existing as a top-layer with a transparency of greater than 0% within a multi-layered DWODC environment, or as an uploaded DCI which is interpreted within the DWODC as establishing boundaries for other included DCIs, which are optionally isolated and sized for insertion within the boundaries upon introduction into the DWODC following user request.

The ability to modify, arrange and order the DCIs within the DWODC, along with the ability to include DCIs from the purchaser's computer system, or a third party computer system; provides the purchaser with an enhanced ability to assess the appropriateness and/or desirability of a DCI available for purchase. The DCIs available for purchase may be purchased through a user interface using one of the means This represents a novel addition to the marketing and purchasing of DCIs.

In another aspect, the present invention provides for a system for communicating to a third party the purchaser's DWODC prior to, or following, the purchase of the DCIs. In a preferred embodiment, the purchaser of the DCI is located at a remote purchase location and communicates with the supplier through a computer system transmitting data through a computer network interface to a pre-programmed main computer of the DCI supplier. Following the generation of the purchaser's DWODC, the purchaser may request the pre-programmed main computer of the DCI supplier to communicate the DWODC to a third party. In a preferred embodiment the communication of the DWODC to a third party is through communication of an invitation to view the DWODC via an electronic mail communication containing a link to a World Wide Web site on the global Internet. The ability to communicate the DWODC to a third party, for example the end-user of a product created by the purchaser, provides the purchaser and end-user with enhanced ability to asses, review and provide feedback relating to the purchase of a DCI.

In another aspect, the present invention provides for a system for arranging, modifying and organizing DCIs within a DWODC for purchase of a representation of the DWODC generated by the system. The representation would contain the entirety, or selected portion of the DWODC created by the user and could be communicated to the user, or a desired third party, by email or other electronic means known in the art. It is contemplated by the present invention that the representation of the created DWODC could be provided in a format for use as desktop “wallpapers” for computer systems or cell phones. Alternatively, the user may choose to purchase the created DWODC in a higher-resolution.

The purchase of a DCI may be enabled through various means known in the art, either through a “one-click” purchase transaction, (U.S. Pat. No. 5,960,411 herein incorporated by reference) or through other means of ecommerce known in the art, see for example U.S. Pat. Nos. 6,205,436, 5,590,197, 5,745,681, 5,727,163, 5,715,399 and 5,715,314; all of which are herein incorporated by reference.

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

### BRIEF DESCRIPTION OF THE DRAWINGS

In the accompanying drawings, which illustrate exemplary embodiments of the present invention:

FIG. 1 is an example illustration of a DWODC system according to the present invention;

FIG. 2 is an example illustration of the initialize phase of the DWODC system of FIG. 1;

FIG. 3 is an example illustration of the process for displaying a DWODC and the process wherein notes are retrieved;

FIG. 4 is an example illustration of the creation of a new DWODC by the user operating the DWODC DWODC client application on the client computer;

FIG. 5 is an example illustration of the interaction of the DWODC client application and the DWODC service during the creation of a new DWODC;

FIG. 6 is an example illustration of how DCIs are added to a DWODC;

FIG. 7 is an example illustration of what occurs when a DCI is added to a DWODC;

FIG. 8 is a diagrammatic illustration of moving a DCI within a DWODC;

FIG. 9 is an example illustration of the process wherein a DCI is moved;

FIG. 10 is an example illustration of resizing a DCI within a DWODC;

FIG. 11 is an example illustration of the process wherein a DCI is resized;

FIG. 12 is an example illustration of cropping of a DCI in a DWODC;

FIG. 13 is an example illustration of the process wherein a DCI is cropped;

FIG. 14 is an example illustration of moving a DCI from one layer to another in a DWODC;

FIG. 15 is an example illustration of the process wherein a DCI is moved between layers;

FIG. 16 is an example illustration of altering the orientation of a DCI in the DWODC by reversing it;

FIG. 17 is an example illustration of the process wherein the orientation of a DCI in the DWODC is altered by reversing it;

FIG. 18 is an example illustration of altering the orientation of a DCI in the DWODC by rotating it;

FIG. 19 is an example illustration of the process wherein the orientation of a DCI in the DWODC is altered by rotating it;

FIG. 20 is an example illustration of changing the transparency of a DCI within a DWODC;

FIG. 21 is an example illustration of the process wherein the transparency of a DCI within a DWODC is altered;

FIG. 22 is an example illustration of the process wherein a DWODC is renamed;

FIG. 23 is an example illustration of the process wherein a DWODC is deleted;

FIG. 24 is an example illustration of sharing a DWODC with another user;

FIG. 25 is a flow diagram illustrating an example communication process which occurs when sharing a DWODC with another user;

FIG. 26 is an flow diagram further illustrating an example communication process when sharing a DWODC with another user;

FIG. 27 is a example illustration of printing a DWODC;

FIG. 28 is an example illustration of the communication process when a user moves the viewable area using the scroll bars;

FIG. 29 is an example illustration of navigating a DWODC using a “zoom” interface;

FIG. 30 is an example illustration of the communication process that occurs when a user navigates using the “zoom” interface;

FIG. 31 is an example illustration of copying or duplicating a DWODC;

FIG. 32 is an example illustration of the communication process of copying or duplicating a DWODC;

FIG. 33 is an example illustration of the process of adding markup to a DWODC;

FIG. 34 is an example illustration of the communication process of adding markup to a DWODC;

FIG. 35 is an example illustration of uploading new DCIs from the client computer to the DWODC;

FIG. 36 is an example illustration of the communication process for uploading new DCIs from the client computer to the DWODC; and

FIG. 37 is an example illustration of two DWODC client applications sharing a single DWODC;

### DETAILED DESCRIPTION AND EXEMPLARY EMBODIMENTS

Referring now in detail to the accompanying drawings, there are illustrated exemplary embodiments of a DWODC system and method according to the present invention. The invention may be practised using any number of software or hardware implementations. In the preferred embodiment the present invention is implemented using Flash® environment, though any number of programming languages or environments can be used to implement the present invention.

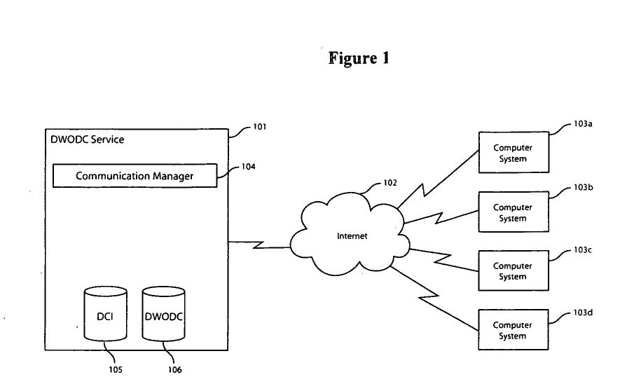

FIG. 1 illustrates a DWODC system according to the present invention, consisting of a DWODC service 101 which is connected to a communication medium, in this embodiment being the Internet 102, which communication medium is in turn connected to one or more computer systems 103a,b,c,d, each running a DWODC client application. The DWODC service is comprised of a communication manager 104 which listens for and responds to requests from the DWODC client application running on the client computer systems 103a,b,c,d. The DWODC service also includes two data repositories, a DCI database 105 and a DWODC database 106.

The DCI database contains information about a particular digital resource, which includes, but is not limited to, the original resource, a proxy representation of the resource, information regarding the author/composer/photographer/typographer/etc. of the resource, licensing costs, licensing restrictions, technical details, etc. One skilled in the art will recognize that the scope of the data contained in the DCI database is not limited to the aforementioned items, but may include a multitude of other desirable data items.

The DWODC database contains information specific to the workspace(s) which users have created, including, but not limited to, a creator's user information, the DCIs displayed on the workspace, the size/location coordinates/visible region/etc. of the DCI, notes displayed on the workspace, as well as the size/location coordinates/colour/etc. of the notes. The DWODC database contains the latest updated information about all workspaces for all users, thereby maintaining the current state of each DWODC and allowing the workspace to be loaded and displayed by the user who created the workspace or by any other user designated by the creator. One skilled in the art will recognize that the DWODC database could contain a variety of other desirable information related to the workspace not specifically mentioned above.

The network connection 102 is integral to one particular embodiment of the present invention, in an environment where the service is connected to one or more networks, remote or local. However, one skilled in the art will recognize that the methods and systems of the present invention may be practiced on processing systems or networks with varying architectures.

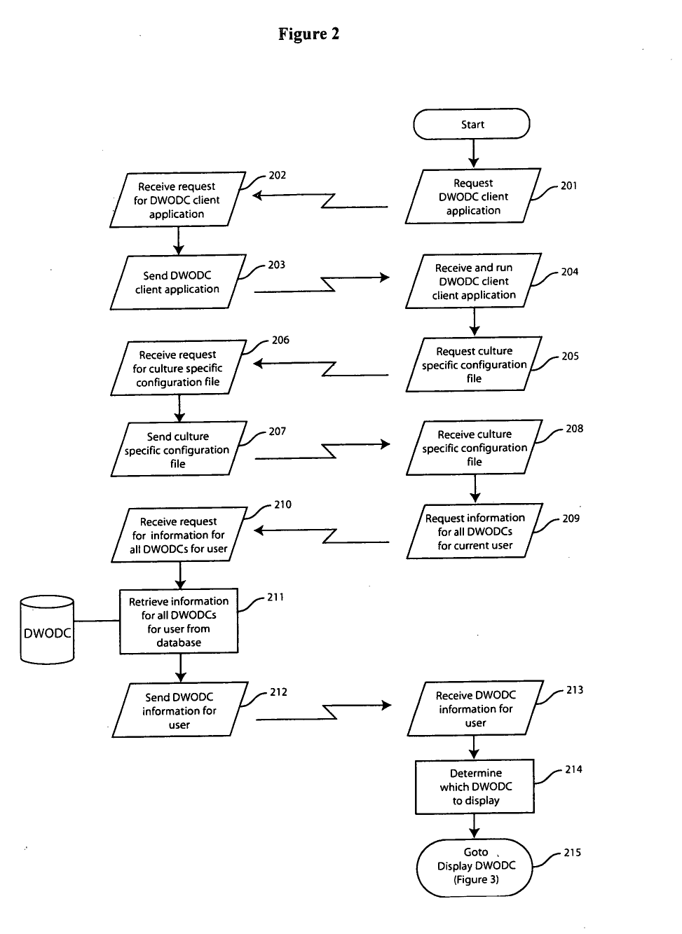

FIG. 2 illustrates the process flow of the initialize phase of the preferred embodiment of the present invention. The client computer system requests the DWODC application from the service at 201. The DWODC receives the request at 202 and sends the DWODC client application at 203. Once received by the user at 204, the DWODC client application begins execution and requests a configuration file at 205, which request is received at 206 and includes: the language used by the client, client country of origin, computer operating system type, etc. An individual skilled in the art will recognize that the request is not limited to these specific items, but may include other information available to the DWODC client application while executing on the client computer. The DWODC service responds by sending back a specific configuration file at 207 based on the information provided by the DWODC client application. The configuration file would then be received by the DWODC client application at 208. This configuration file can include, but is not necessarily limited to: language/country/culture-specific user interface elements, instructions to change/limit/enhance the DWODC client application's behaviour, etc. A person skilled in the art will recognize that the configuration file can contain a multitude of information and/or execution instructions which would be available to the DWODC service at the point of execution, and need not be limited to the specifically mentioned items.

In the preferred embodiment of the invention illustrated in FIG. 2, the DWODC client application would then request all of the DWODCs for the current user from the DWODC service at 209. The current user of the DWODC client application would be known to the application as a unique individual that was authorized and authenticated. One skilled in the art will understand that this authorization and authentication could take many forms and that the methods and systems of the present invention may be practiced by authorizing and authenticating the specific user from within the DWODC client application. In an alternative embodiment, the present invention may be practiced by requesting only the DWODCs that need to be displayed at that point in time, and may use a multitude of caching methods to request only the incremental information required by the application.

Upon receiving the request for the DWODCs at 210, the DWODC service retrieves the requested information from the DWODC database at 211 and sends the information to the DWODC client application at 212. The DWODC information would include information related to the workspace, including, but not limited to, the creator's user information, the DCIs displayed on the workspace, the size/location coordinates/visible region/etc. of the DCI, notes displayed on the workspace, as well as the size/location coordinates/colour/etc. of the notes. One skilled in the art will realize that the DWODC database could contain a variety of other useful information related to the workspace not specifically mentioned.

The DWODC client application then receives the DWODC information at 213 and then determines which DWODC to display at 214 and this becomes the current DWODC. In the preferred embodiment of the invention, the default DWODC is determined by either: displaying an empty default DWODC in the instance of first time use, displaying the DWODC that was displayed the last time the user accessed the system, or displaying the first DWODC found by alphabetic sorting of the DWODC names. A person skilled in art will recognize that many other methods could be used to determine which DWODC to display, other than the method specifically mentioned.

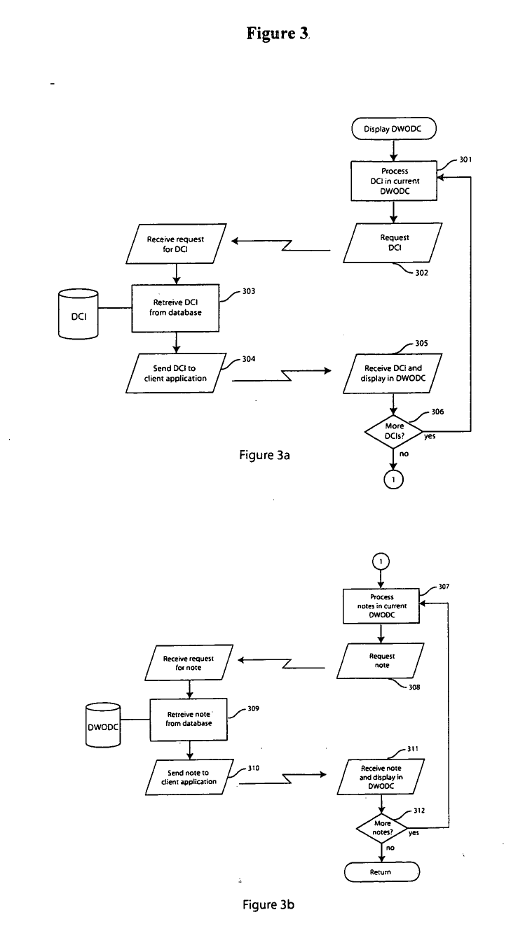

After determining which DWODC to display the DWODC client application would proceed to display at 215 the current DWODC on the user's computer screen, as detailed in FIG. 3a and described below.

FIG. 3a illustrates the process for displaying a DWODC. The DWODC client application begins processing the DCIs that are related to the current DWODC at 301. The DWODC client application will then iterate through each DCI contained on the current DWODC, and request the DCI from the DWODC service at 302. The DWODC service then retrieves the DCI from the DCI database at 303, and sends the DCI at 304 to the DWODC client application. Using the information previously retrieved regarding the DWODC at 207, the DWODC client application retrieves and displays the DCI on the workspace at 305 using the location/size coordinates stored with the DWODC. If there are no more DCIs at 306, the process continues as described below.

FIG. 3b illustrates the remainder of the process of displaying a DWODC. The DWODC client application processes the notes that are related to the current DWODC at 307. The DWODC client application will then iterate through each note contained on the current DWODC, and request the note at 308 from the DWODC service. The DWODS service then retrieves the note from the DWODC database at 309, and sends the note to the DWODC client application at 310. Using the information previously retrieved regarding the DWODC 211 the DWODC client application receives and displays the note on the workspace at 311 using the location/size coordinates stored with the DWODC. If there are more notes at 312, the process returns to 307.

In the preferred embodiment of the present invention, the notes are retrieved in a separate process to optimize data transfer over the network; however, one skilled in the art will recognize that the methods and systems of the present invention could be practiced by retrieving the note information at other times in the process flow. In one non-limiting embodiment the note information is retrieved concurrent with the retrieval of the DWODC information at 211.

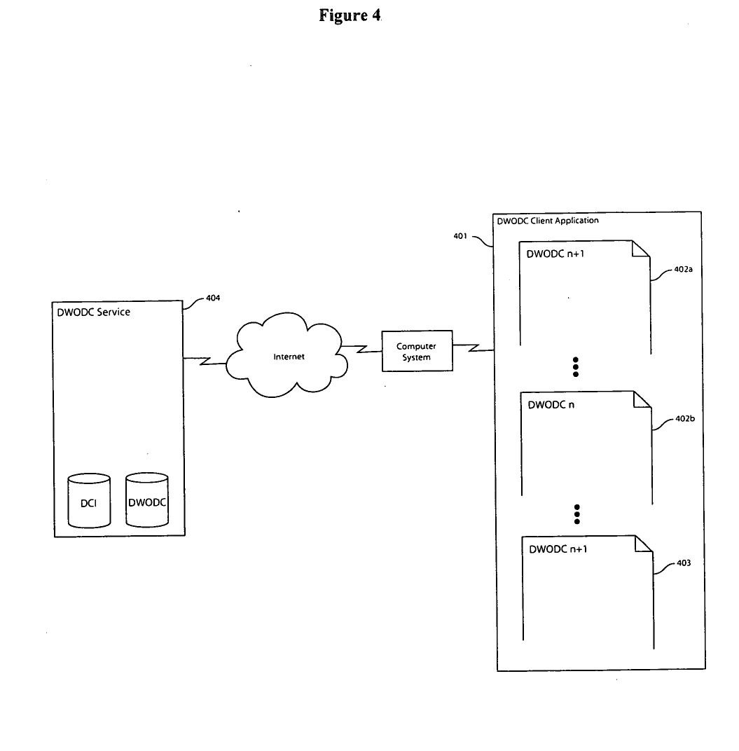

FIG. 4 illustrates the creation of a new DWODC by the user operating the DWODC client application. The DWODC client application 401 manages a plurality of DWODCs 402a,b. The user has the ability to create a new DWODC 403 by interacting with the DWODC Service 404.

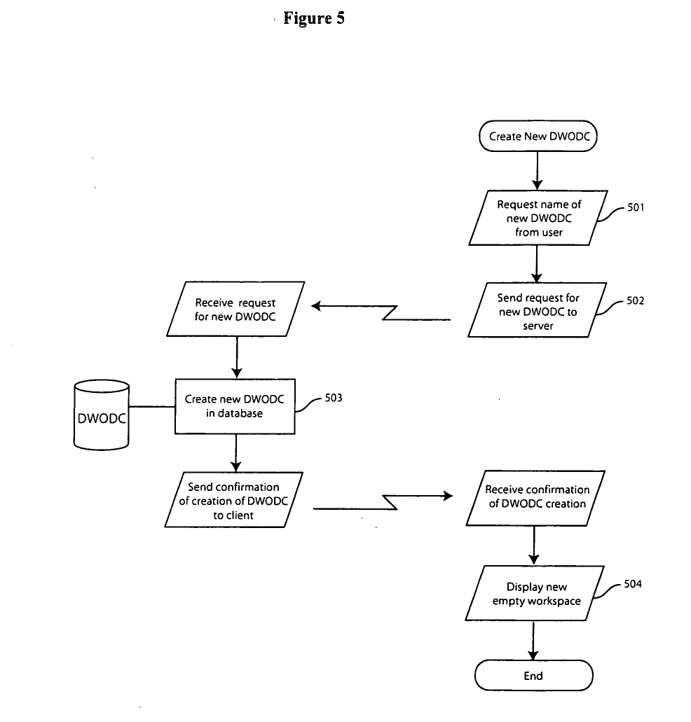

FIG. 5 illustrates the process flow of the interaction of the DWODC client application and the DWODC service during the creation of a new DWODC. In the preferred embodiment, the DWODC client application begins by querying the user at 501 to provide a name for the DWODC to be created, then sends a request at 502 to the DWODC service which includes the name provided by the user. Upon receiving the request the DWODC service creates a new DWODC in the DWODC database at 503, and then sends a confirmation back to the DWODC client application which upon receiving the confirmation displays a new empty DWODC 504. In an alternative embodiment, the present invention is practiced by creating a new DWODC and pre-populating it with a set of DCIs which could be specified by either the DWODC service or the DWODC client application.

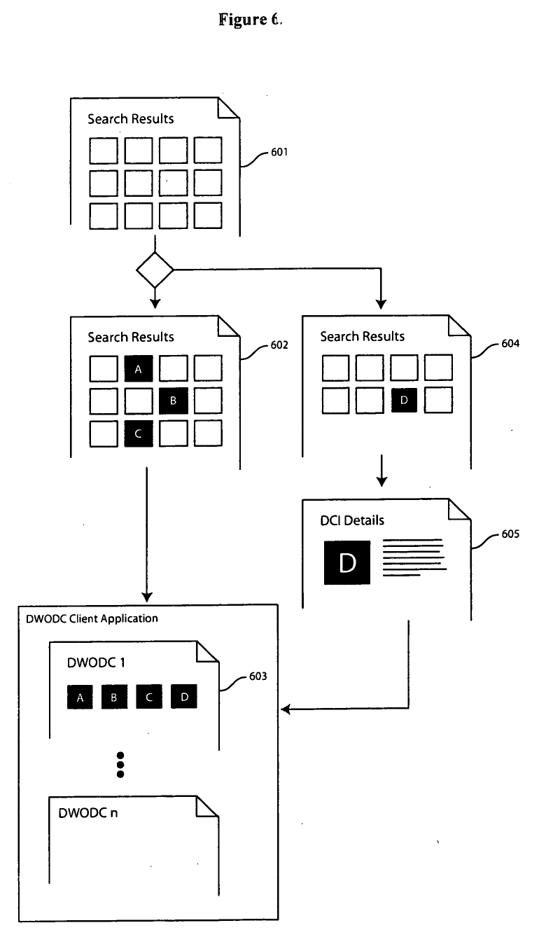

FIG. 6 illustrates how DCIs are added to a DWODC. First, the user is presented with multiple DCIs at 601 from which the user may either: select multiple DCIs at 602 and add them to the DWODC at 603, or select an individual DCI at 604, to view further information and details relating to the DCI at 605. Further information and details relating to the DCI can include, but are not limited to, information relating to the author/composer/photographer/typographer, the original source of the DCI, licensing costs, licensing restrictions, technical details, etc. One skilled in the art is capable of selecting and modifying the listing of the further information and details relating to the DCI as appropriate for the type of the DCI, the customers using the DWODC service, etc. At this point the user may choose to add this individual DCI to the DWODC at 603.

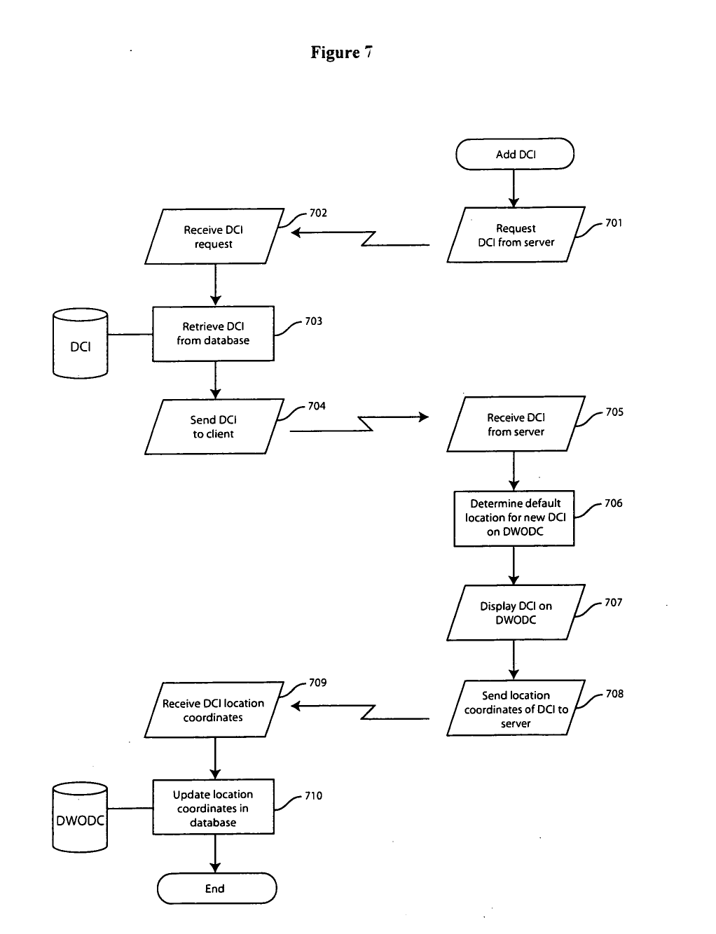

FIG. 7 illustrates the process flow which occurs when a DCI is added to a DWODC. First, the DWODC client application sends a request for the DCI to the DWODC service at 701. This request includes, but is not limited to, a unique identifier or list of unique identifiers which the DWODC client application has received from another application; for example, a web browser running on the client computer. One skilled in the art will recognize that these identifiers could also be entered directly into the DWODC client application. The request is then received by the DWODC service at 702, which retrieves the DCI from the database at 703 and then sends the information back to the DWODC client application at 704.

Upon receiving the DCI from the DWODC service at 705, the DWODC client application determines the default location for the DCI within the current DWODC at 706. In the preferred embodiment of the present invention, the method for determining the location is to find a location on the current DWODC that is un-occupied by another DCI, scanning the current visible region of the workspace from top, left to bottom, right. If the visible region of the current workspace does not have any available space for the DCI its location defaults to the centre of the visible region of the current workspace and is layered on top of all other DCIs which currently occupy this space. A person skilled in the art will recognize that the systems and methods of the present invention may be practiced using other algorithms to determine the location of a newly added DCI.

Once a default location has been determined for the DCI it is displayed on the current DWODC in that location at 707, and the location coordinates are sent to the DWODC service at 708. Once the location coordinates are received by the DWODC service at 709, the location of the DCI in the user's current DWODC is updated in the DWODC database at 710. One skilled in the art will recognize that the process of finding a location on the DWODC for the DCI could be performed on the server rather than at the client.

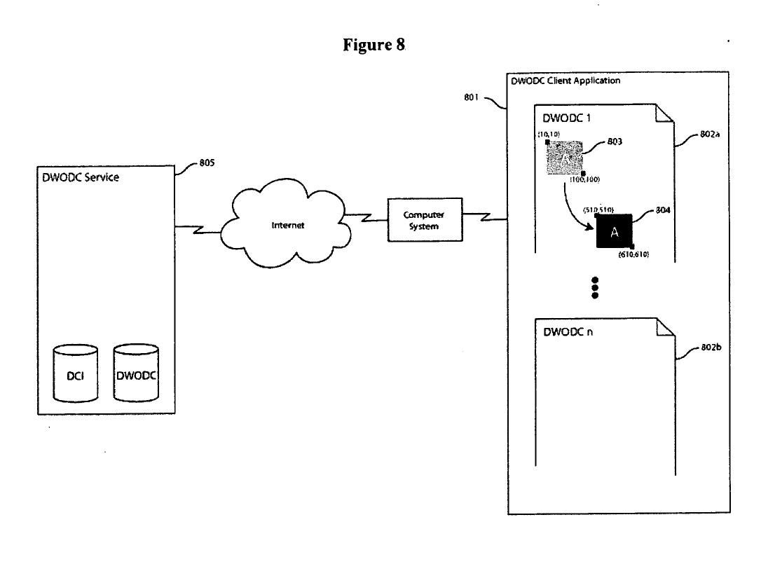

FIG. 8 illustrates moving a DCI within a DWODC. The DWODC client application 801 provides user interface elements for the selection of DCIs within a DWODC 802a,b, and these selected DCIs are capable of being moved with various other interface elements including dragging the DCI, using the keyboard, etc. When the user selects a DCI and moves it from one location 803 to a new location 804 the DWODC client application 801 shows the DCI in the new location 804 and then communicates this to the DWODC service 805.

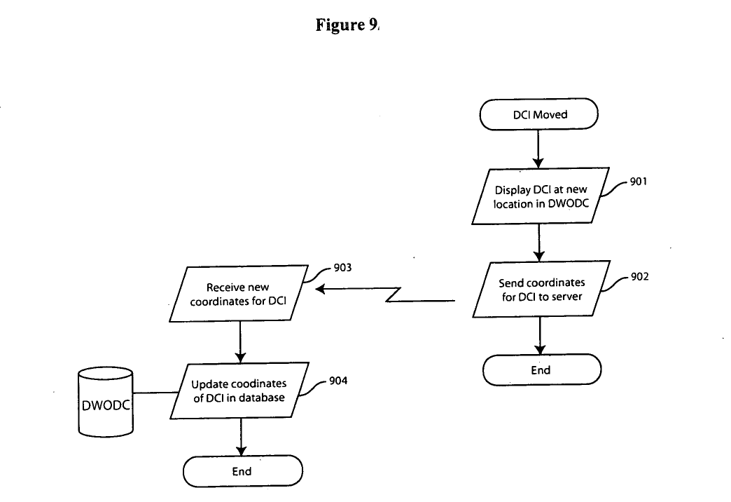

FIG. 9 illustrates the process flow which occurs when a DCI is moved. In a preferred embodiment of the present invention, once the DWODC client application displays the DCI in the new location at 901, the DWODC client application sends the new location coordinates of the DCI to the DWODC service at 902. Upon receiving the new location coordinates at 903, the DWODC service updates the DWODC database at 904 with the new location coordinates for the DCI which was moved.

In alternative embodiments this communication may occur during or after the move of the DCI, the communication could utilize any protocol, and the information transmitted is not necessarily limited to the new location coordinates of the DCI and could include other data not specifically mentioned.

A person skilled in the art will recognize that multiple DCIs could be selected and moved simultaneously by giving the user the ability to select multiple DCIs and move them within the workspace, then to send a list of DCIs and new location coordinates to the DWODC servce.

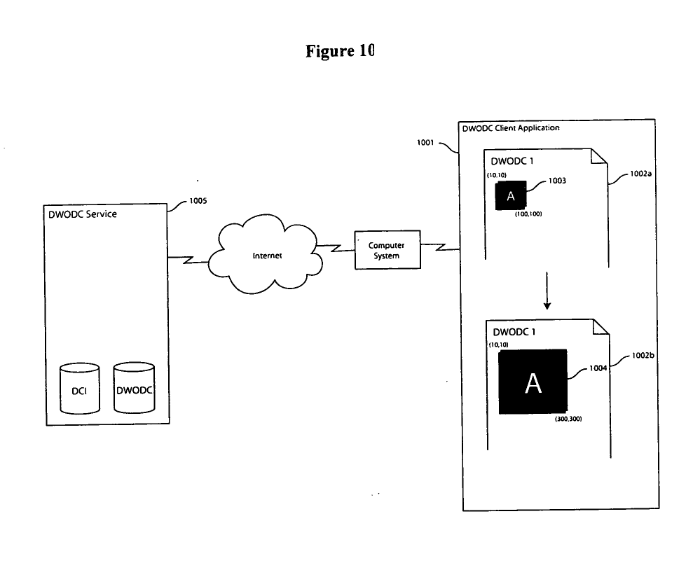

FIG. 10 illustrates resizing a DCI within a DWODC. The DWODC client application 1001 provides user interface elements for the selection of DCIs, within a DWODC 1002a,b, and these selected DCIs could be resized with various other interface elements including dragging a corner/edge of the DCI, using the keyboard, entering a scaling value into a dialog box, etc. When the user selects a DCI at size 1003 and resizes it to size 1004, the DWODC client application 1001 sends the new size/location coordinates to the DWODC service 1005.

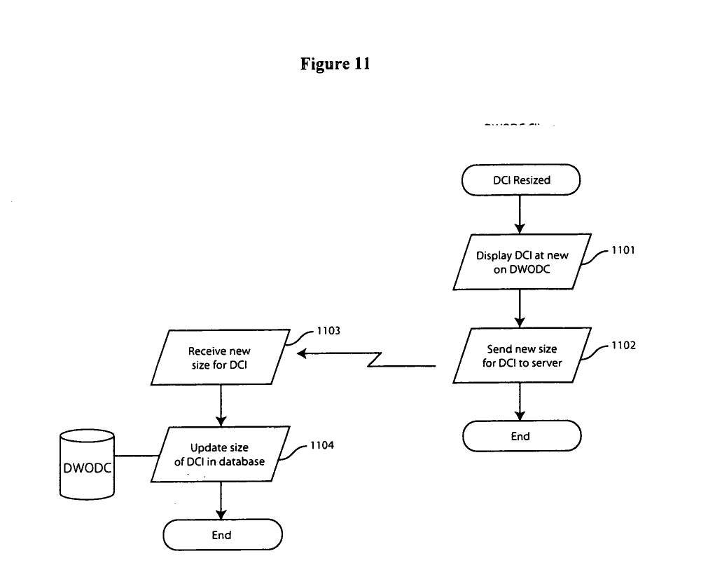

FIG. 11 illustrates the process flow which occurs when a DCI is resized. In a preferred embodiment of the present invention, once the DWODC client application displays the DCI in the new size at 1101, the DWODC client application sends the new size/location coordinates of the DCI to the DWODC service at 1102. Upon receiving the new location coordinates at 1103, the DWODC service updates the DWODC database at 1104 with the new size coordinates for the DCI which was moved.

In alternative embodiments this communication may occur during or after the move of the DCI, the communication could utilize any protocol, and the information transmitted is not necessarily limited to the new size/location coordinates of the DCI and could include other data not specifically mentioned.

A person skilled in the art will recognize that multiple DCIs could be selected and resized simultaneously by giving the user the ability to select multiple DCIs and resize them within the workspace, then send a list of DCIs and new size/location coordinates to the DWODC service.

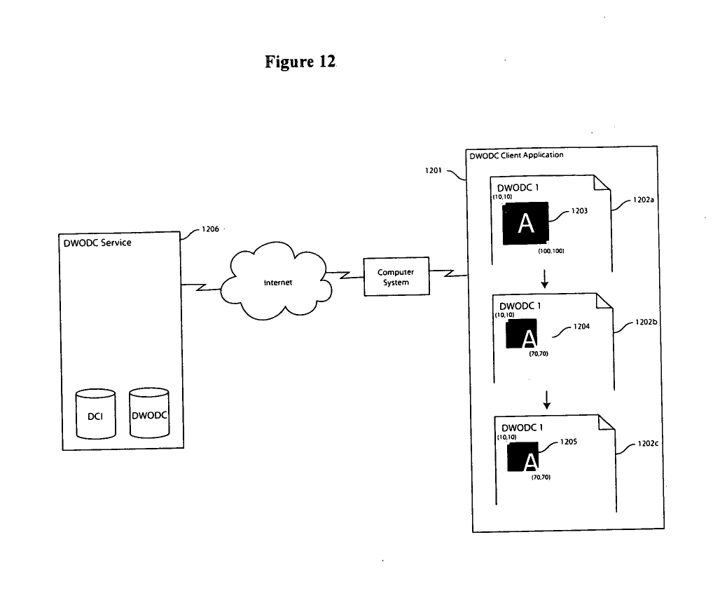

FIG. 12 illustrates the cropping of a DCI in a DWODC. Cropping is the process of altering the visible area of a DCI. The DWODC client application 1201 provides user interface elements for the selection of DCIs within a DWODC 1202a,b,c and these selected DCIs could be cropped with various other user interface elements including dragging a corner/edge of the DCI, using the keyboard, entering a scaling value into a dialog box, etc. In a preferred embodiment, when the user selects a DCI at 1203 and crops it as at 1204 to form cropped DCI 1205, the DWODC client application 1201 sends the new size/crop size/location coordinates of the cropped DCI 1205 to the DWODC service 1206.

In an alternative embodiment, this communication may occur during or after the cropping of the DCI, the communication could utilize any protocol, and the information transmitted need not be limited to the new size/location coordinates of the DCI and could include other data not specifically mentioned.

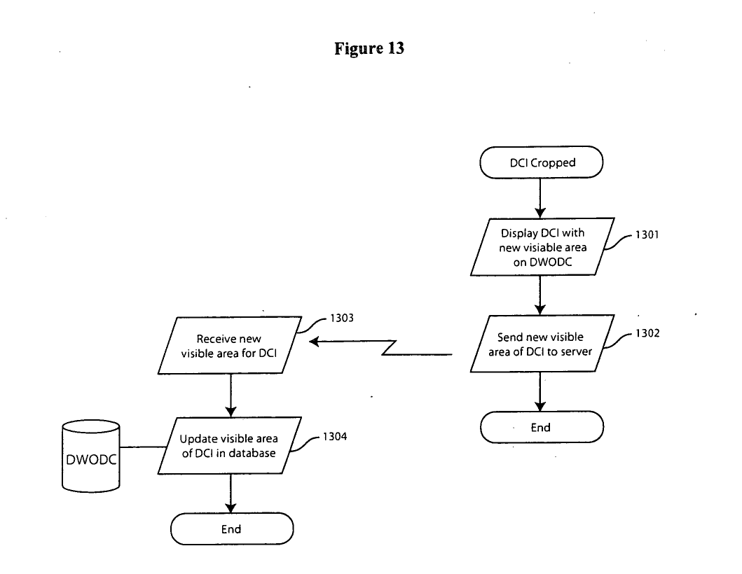

FIG. 13 illustrates the process flow which occurs when a DCI is cropped. Once the DWODC client application displays the DCI in the new size at 1301, the DWODC client application sends the new size/crop information/location coordinates of the DCI to the DWODC service at 1302. Upon receiving the new size/crop information/location coordinates at 1303, the DWODC service updates the DWODC database at 1304 with the new size/crop information/location coordinates for the DCI which was cropped.

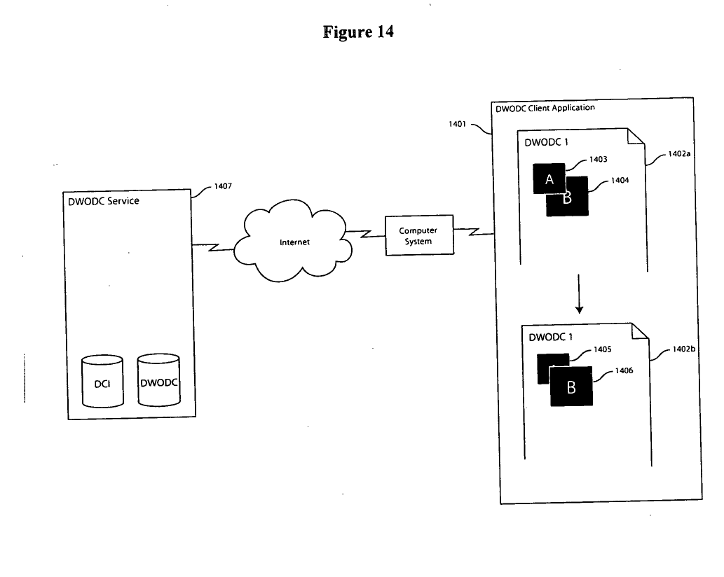

FIG. 14 illustrates moving a DCI from one layer to another in a DWODC. Because multiple DCIs can exist in the same two dimensional space, a third dimension—referred to as a “layer”—is used to determine which DCI should be displayed to the user (i.e. “in front”). The DWODC client application 1401 provides user interface elements for the selection of DCIs within a DWODC 1402a,b and these selected DCIs could be moved to other layers with various other user interface elements including a menu with various options for changing layers, using the keyboard, entering a layer value into a dialog box, etc. If two DCIs co-exist in the same two dimensional space, or overlap, the DCI that is on the higher layer will appear to be on top of the DCIs on lower layers, as shown at 1403 and 1404, where 1403 is “on top of” 1404. The user could select a DCI on the lower layer such as 1405, then use one of the user interface elements to move that DCI to a higher layer, so that it would appear to be in front of 1406 and all DCIs on lower layers. The DWODC client application 1401 sends the new layer information and DCI content of the layers to the DWODC service 1407.

A person skilled in the art will recognize that the movement of DCIs between layers could be done with varied degrees of granularity, with the DCI moving completely in front/behind of all other layers, or incrementally one layer at a time.

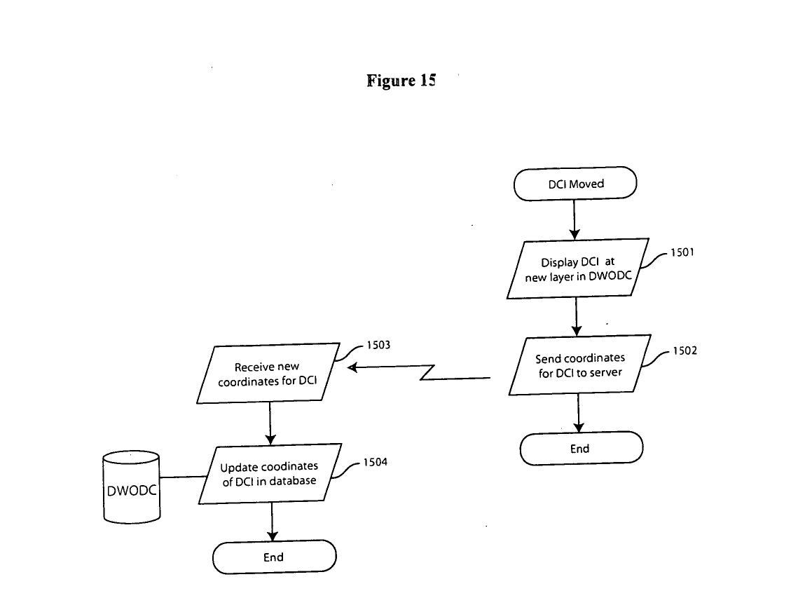

FIG. 15 illustrates the process flow which occurs when a DCI is moved between layers. Once the DWODC client application displays the DCI layer relative to all other DCIs at 1501, the client sends the new layer information of the DCI to the DWODC service at 1502. Upon receiving the new layer information at 1503, the DWODC service updates the DWODC database at 1504 with the new layer information for the DCI which was moved.

A person skilled in the art will recognize that multiple DCIs could be selected simultaneously, and moved to other layers within the workspace, then send a list of DCIs and layer information to the DWODC service.

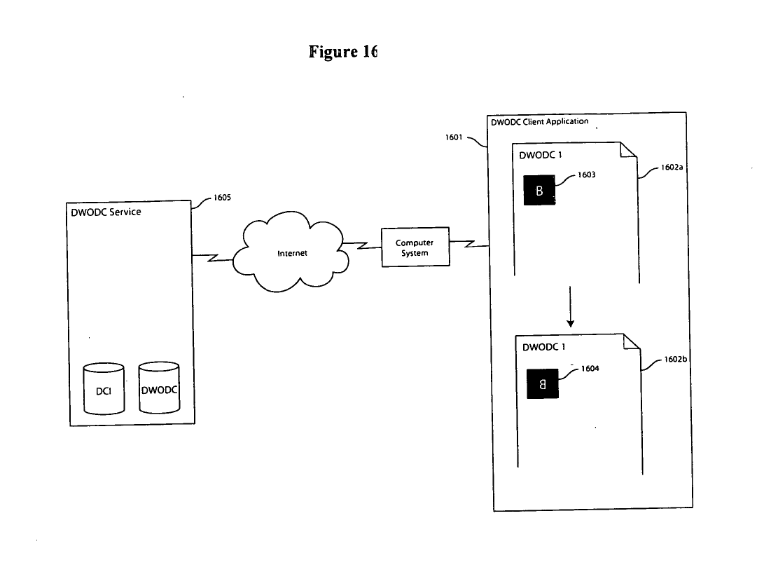

FIG. 16 is an example of “flipping” or reversing a DCI, altering its orientation in the DWODC. The DWODC client application 1601 provides user interface elements for the selection of DCIs within a DWODC 1602a,b, and the orientation of these selected DCIs can be changed with various other interface elements including dragging the DCI, using the keyboard, etc. For example a DCI can be flipped along a horizontal or vertical axis. When the user selects a DCI at 1603 and changes its orientation at 1604, the DWODC client application 1601 displays the DCI in the new orientation 1604 and then communicates with the DWODC service 1605.

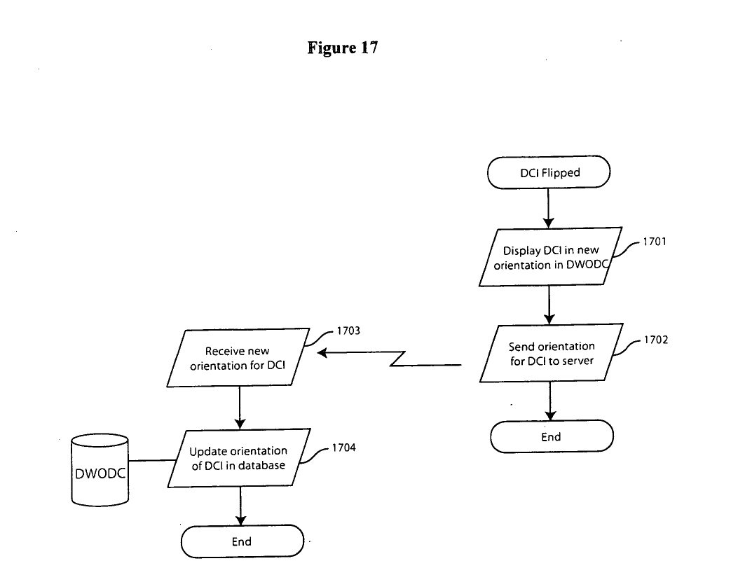

FIG. 17 illustrates the process flow which occurs when a DCI is flipped. In a preferred embodiment of the present invention, once the DWODC client application displays the DCI in the new orientation at 1701, at 1702 the DWODC client application sends the orientation information of the DCI to the DWODC service. Upon receiving the new orientation data at 1703, the DWODC service updates the DWODC database at 1704 with the new orientation information for the DCI which was flipped.

In alternative embodiments this communication may occur during or after altering the orientation of the DCI, the communication could utilize any protocol, and the information transmitted need not necessarily be limited to the new orientation of the DCI and could include other data not specifically mentioned.

A person skilled in the art will recognize that multiple DCIs could be selected and flipped simultaneously by giving the user the ability to select multiple DCIs and move them within the workspace, then send a list of DCIs and new orientation data for each DCI to the DWODC service.

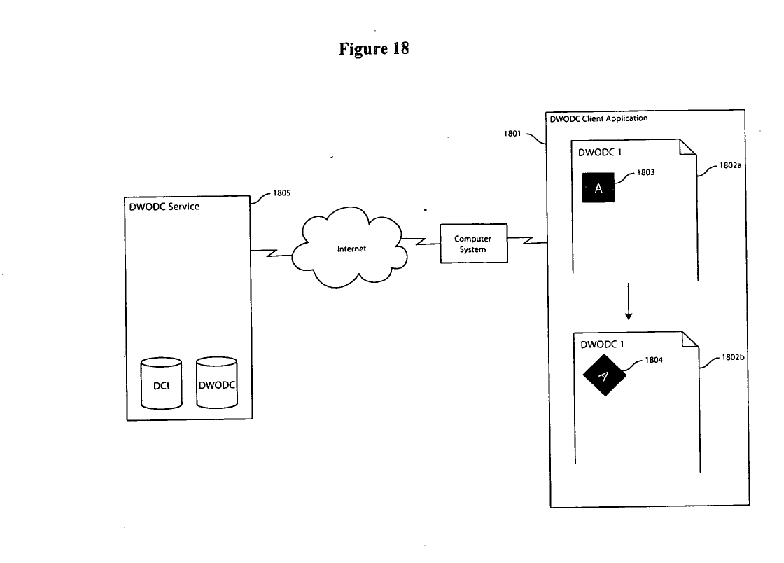

FIG. 18 illustrates rotating a DCI, altering its orientation in the DWODC. The DWODC client application 1801 provides user interface elements for the selection of DCIs within a DWODC 1802a,b, and the orientation of these selected DCIs can be changed with various other interface elements including dragging the DCI, using the keyboard, etc. When the user selects a DCI at 1803 and changes its orientation as at 1804, the DWODC client application 1801 displays the DCI in the new orientation 1804 and then communicates with the DWODC service 1805.

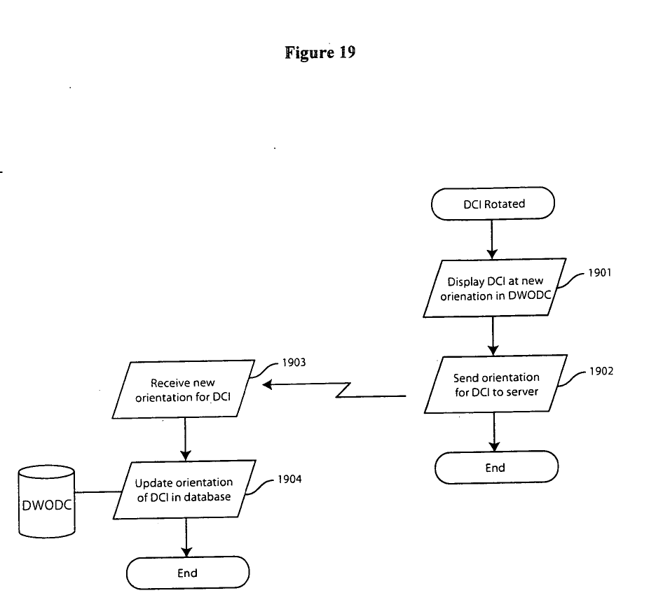

FIG. 19 illustrates the process flow which occurs when a DCI is rotated. In. a preferred embodiment of the present invention, once the DWODC client application displays the DCI in the new orientation at 1901, the DWODC client application sends the orientation information of the DCI to the DWODC service at 1902. Upon receiving the new orientation data at 1903, the DWODC service updates the DWODC database at 1904 with the new orientation information for the DCI which was rotated.

In alternative embodiments this communication may occur during or after altering the orientation of the DCI, the communication could utilize any protocol, and the information transmitted need not necessarily be limited to the new orientation of the DCI and could include other data not specifically mentioned.

A person skilled in the art will recognize that multiple DCIs could be selected and rotated simultaneously by giving the user the ability to select multiple DCIs and move them within the workspace, then send a list of DCIs and new orientation data for each DCI to the DWODC service.

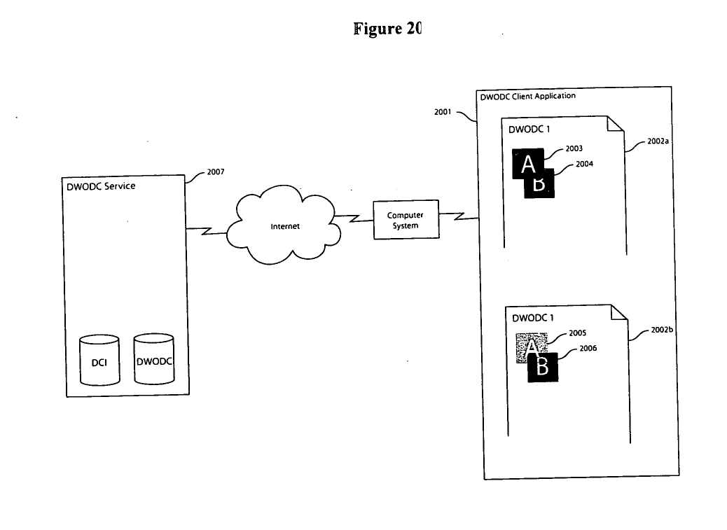

FIG. 20 is an exemplary illustration of changing the transparency of a DCI within a DWODC. The DWODC client application 2001 provides user interface elements for the selection of DCIs within a DWODC 2002a,b, and the transparency of these selected DCIs can be changed with various other interface elements including dragging the DCI, using the keyboard, etc. When the user selects a DCI at 2003 and changes its transparency as at 2005, the DWODC client application 2001 displays the DCI at the new transparency level 2005 allowing any DCI 2004 located below it to become visible as at 2006. The DWODC client application then sends the new transparency information to the DWODC service 2007.

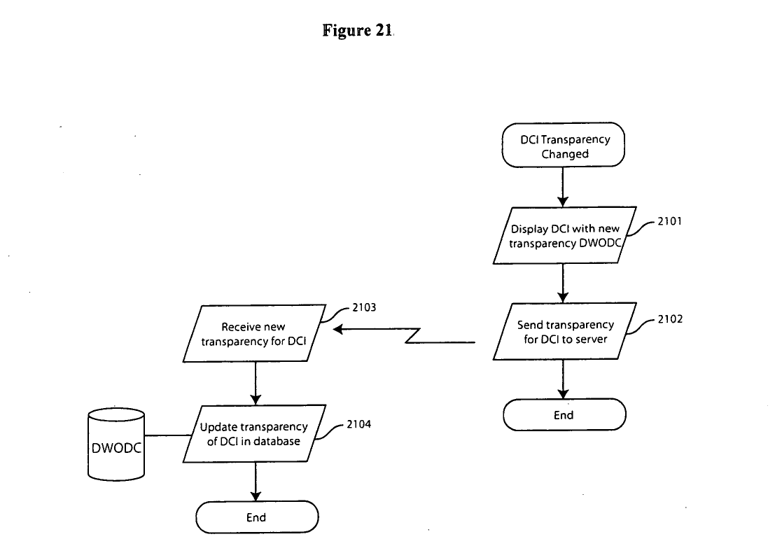

FIG. 21 illustrates the process flow which occurs when the transparency of a DCI is altered. In a preferred embodiment of the present invention, once the DWODC client application displays the DCI at the new transparency level at 2101, the DWODC client application sends the transparency information of the DCI to the DWODC service at 2102. Upon receiving the new transparency data at 2103, the DWODC service updates the DWODC database at 2104 with the new transparency information for the DCI.

In alternative embodiments this communication may occur during or after altering the transparency level of the DCI, the communication could utilize any protocol, and the information transmitted need not necessarily be limited to the transparency value of the DCI and could include other data not specifically mentioned.

A person skilled in the art will recognize that multiple DCIs could be selected and their transparency values altered simultaneously by giving the user the ability to select multiple DCIs and move them within the workspace, then send a list of DCIs and new transparency data for each DCI to the DWODC service.

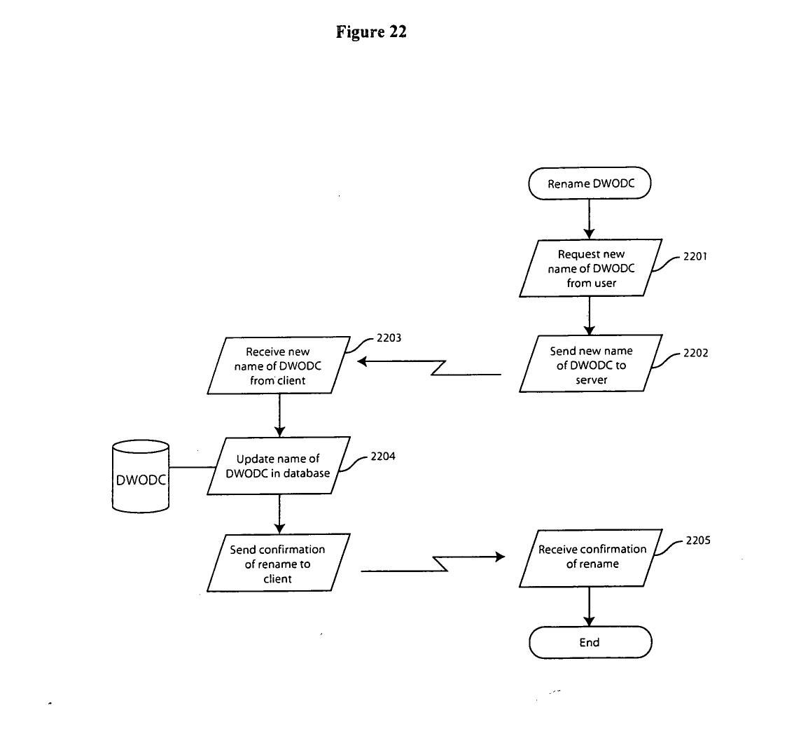

FIG. 22 illustrates the process flow which occurs when a DWODC is renamed. The DWODC application allows users to assign names to each of their workspaces, and provides user interface elements for changing the name of a workspace. When a user chooses to change the name of a workspace, the DWODC client application asks the user to enter a new name at 2201, then a request to change the name of the current workspace is sent to the DWODC service at 2202. Once the request is received at 2203, the DWODC service updates the name in the DWODC database at 2204 and sends a confirmation of the change to the DWODC client application. The DWODC client application receives the change confirmation at 2205 and completes any user interface updates that are required.

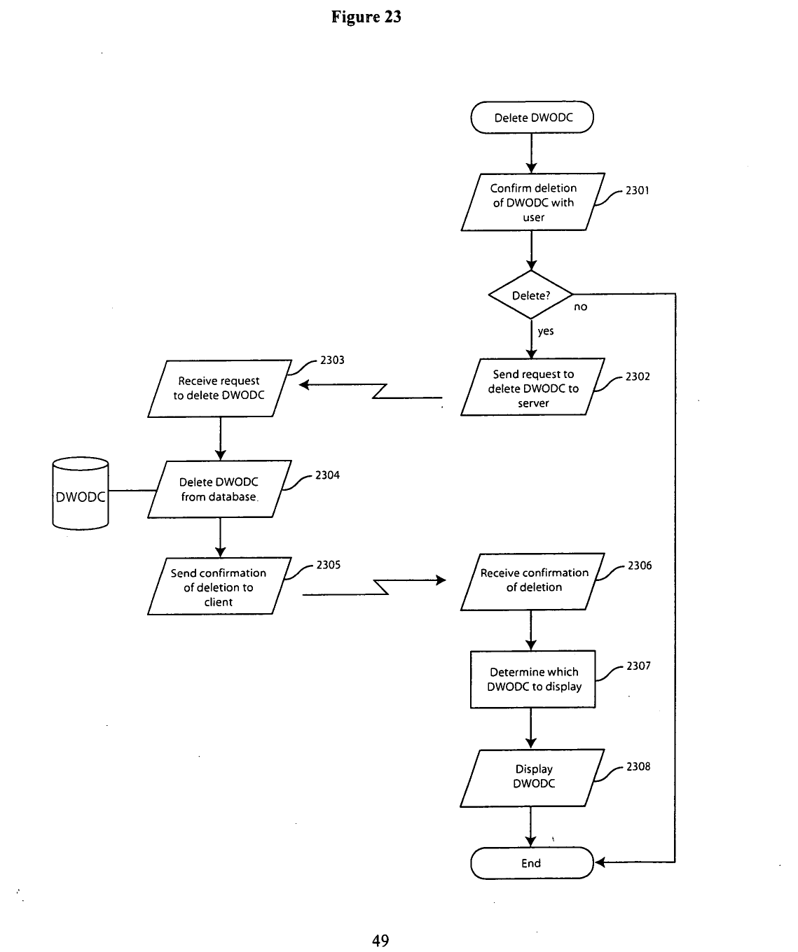

FIG. 23 illustrates the process flow which occurs when a DWODC is deleted. The DWODC client application provides user interface elements for deleting workspaces. These user interface elements include, but are not limited to, menu with a delete option, a button, or keyboard shortcuts. When the user chooses to delete a workspace, the DWODC client application queries the user to confirm this request at 2301. If the user confirms the request, a message is sent by the DWODC client application to the DWODC service at 2302 to delete the specified workspace. Upon receipt of the deletion request at 2303, the DWODC service deletes the workspace from the database at 2304 and sends a confirmation message to the DWODC client application at 2305. Upon receipt of the confirmation message at 2306 the DWODC client application determines which workspace to display as the current workspace at 2307. In the exemplary embodiment, the default workspace after a work space has been deleted is the first DWODC when all of the workspace names are sorted alphabetically. Once the new default, or current, workspace has been determined the workspace is displayed by the DWODC client application at 2308.

A person skilled in the art will recognize that the methods and systems of the present invention can be practiced utilizing various other algorithms for determining the default DWODC to display after a deletion event.

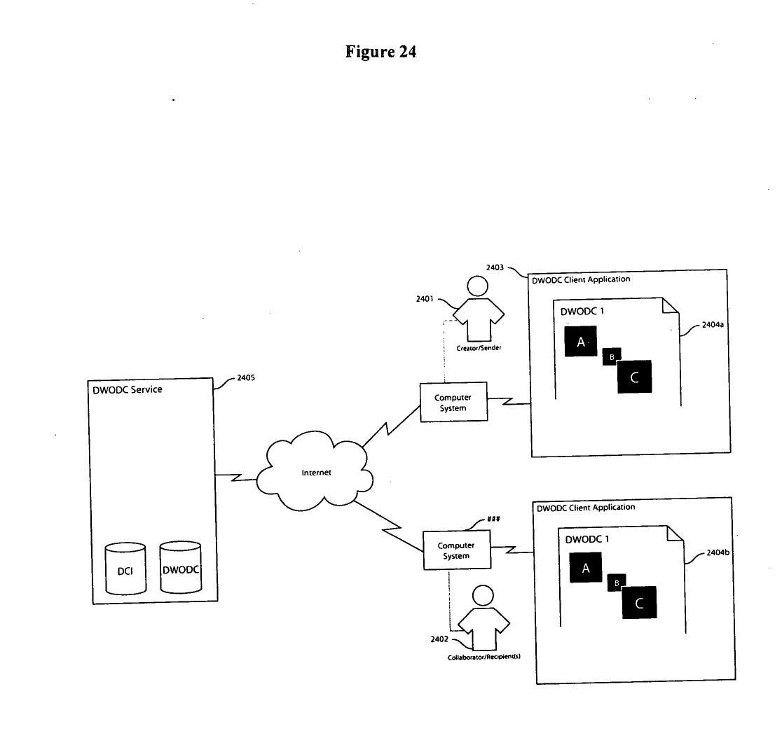

FIG. 24 illustrates sharing a DWODC with another user. Workspaces are created by an individual 2401 and may be shared with many other users 2402. The DWODC client application 2403 allows the creator 2401 to share a workspace 2404a,b by sending a request to the DWODC service 2405. The DWODC service then sends a message to the recipient(s) 2402 and provides them with access to the same workspace 2404a,b.

In the preferred embodiment of the present invention, the message that is sent from the DWODC service to the recipients is an e-mail message. One skilled in the art will be able to practice the systems and methods of the present invention using other types of messaging systems, such as instant messaging systems, wireless messaging, etc.

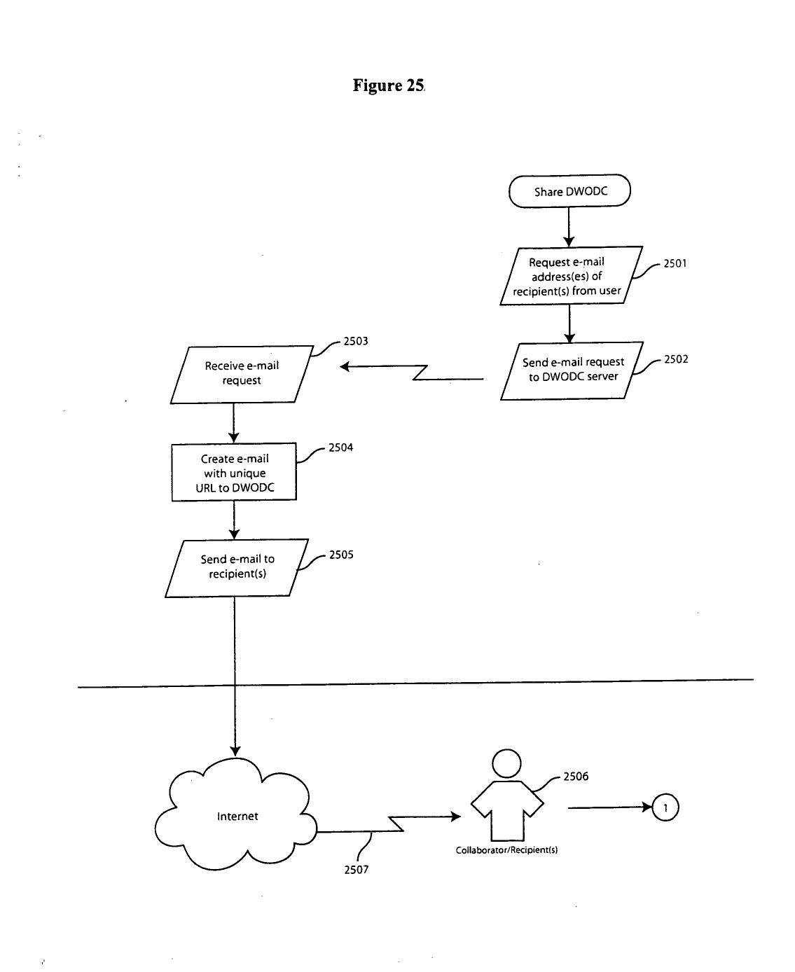

FIG. 25 illustrates the communication process which occurs when sharing a DWODC with another user. The DWODC client application provides user interface elements for sending workspaces to another user, including menu with a send option, a button, or keyboard shortcuts. When the creator of the workspace chooses to send a workspace, the DWODC client application asks the user to fill out a form at 2501 which includes, but is not limited to, the e-mail addresses of the recipient(s), a subject for the message, and any text they want to include with the message. One skilled in art will be able to modify the contents of the form to include other information that may be appropriate for the products being sent, type of user, country of usage, etc.

After the user has filled out the form, the DWODC client application sends a request to the DWODC service at 2502. Upon receipt of the request at 2503, the DWODC service creates an e-mail message to the recipient(s) which includes a unique URL to the workspace to be sent at 2504. The DWODC service then sends an e-mail message to the recipient(s) at 2505. When the recipient 2506 checks their e-mail they will receive the e-mail message at 2507 with the link to the DWODC.

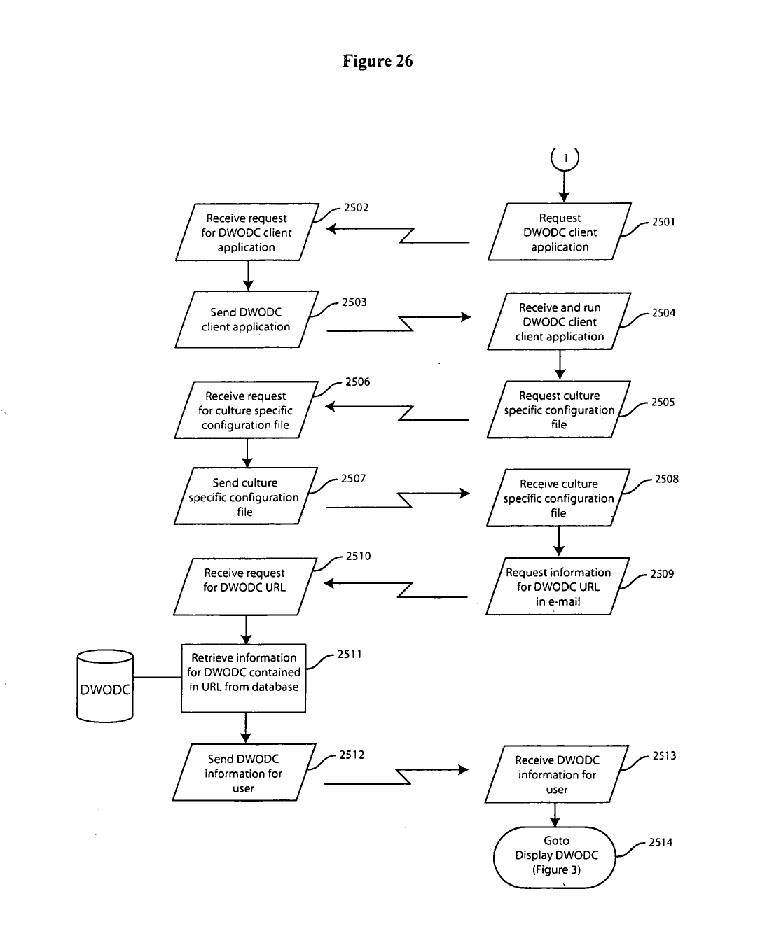

FIG. 26 further illustrates the communication process, specifically when the user clicks on the link, and the initialization process begins with the client computer system requesting the DWODC client application at 2501 from the DWODC service. The DWODC service receives the request at 2502 and sends the DWODC client application at 2503. Once received at 2504, the DWODC client application begins execution and requests a configuration file at 2505, and this request may include: the language used by the client, country of origin, computer operating system type, etc. An individual skilled in the art will recognize that the scope is not limited to these specific items, but may include other information available to the DWODC client application while executing. The DWODC service received the request at 2506 and responds by sending back a specific configuration file at 2507 based on the information provided by the DWODC client application. The configuration file is then received by the DWODC client application at 2508.

This configuration file can include, but need not be limited to: language/country/culture specific user interface elements, instructions to change/limit/enhance the DWODC client application's behaviour, etc. A person skilled in the art will recognize that the configuration file can contain a multitude of information and/or execution instructions which would be available to the DWODC service at the point of execution, and need not be limited to the specifically mentioned items.

The DWODC client application sends a request for the DWODC contained in the URL from the DWODC service at 2509.

Upon receiving the request for the DWODC at 2510, the DWODC service retrieves the requested information from the DWODC database at 2511 and sends the information to the DWODC client application at 2512.

The DWODC information would include information related to the workspace, including, but not limited to, the creator's user information, the DCIs displayed on the workspace, the size, location, coordinates, or visible region. of the DCI, notes displayed on the workspace, as well as the size/location coordinates/colour/etc. of the notes. One skilled in the art will realize that the DWODC database could contain a variety of other information related to the workspace not specifically mentioned. The DWODC client application receives the DWODC information at 2513 and would proceed to display the DWODC on the user's computer screen at 2514 as detailed in the description of FIG. 3 above.

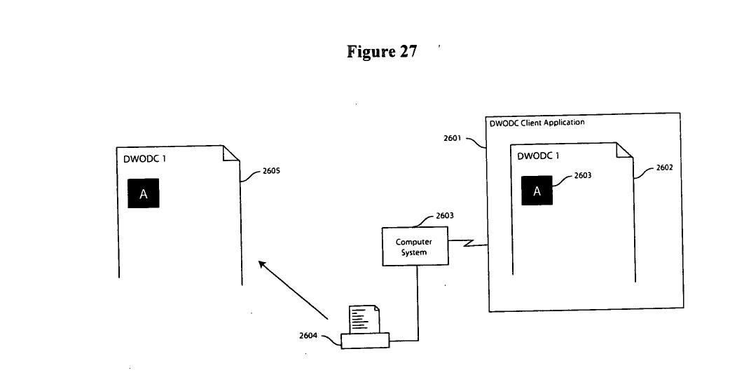

FIG. 27 is an example of printing a DWODC. The DWODC client application 2601 provides user interface elements for printing one, all, or a selection of DWODCs. The computer system 2603 running the DWODC client application 2601 would have a printing device 2604, either directly attached or accessible through a computer network, and the DWODC client application 2601 would send the DWODC 2602 containing DCI 2603 to the printer 2604 and the printer would output the workspaces to the devices preferred media, which in this case is paper 2605.

Alternatively the DWODC client application 2601 could provide user elements for creating a DWODC representation of one, all or a portion of, the DWODCs, the DWODC representation is then communicated to the user or a user designate. In the preferred embodiment, the DWODC representation is generated by the DWODC service and then communicated to the user computer system in an image format. Alternatively the user may request the DWODC service to communicate the DWODC representation to an alternate destination, such alternate destinations including but not limited to a cell phone, or third party computer system. The means of communication may be by a communications network such as the global Internet or other electronic network, using various communications protocols, for example by electronic mail.

It is contemplated by the present invention that the DWODC may serve in the arranging, modifying and organizing of DCIs in the context of purchase of DCIs from a vendor, as well as allowing the communication of communication of DWODCs to third parties in the context of DCI purchase. Furthermore, the invention contemplates the purchase of the DWODC representation for use by the user or a third party in various applications, such as computer desktop graphics, cellular phone displays, web sites, etc.

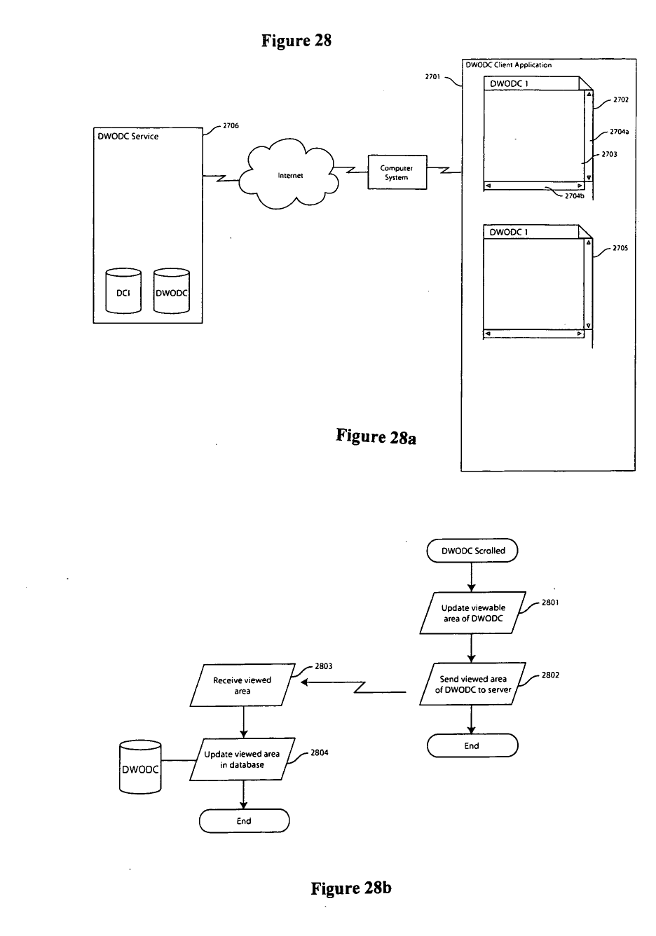

FIG. 28a is an example of navigating a DWODC by the user, moving the viewable area using scroll bars. When the DWODC exceeds the size of the window within the DWODC client application 2701, only a portion of the DWODC is displayed. The portion displayed is the viewable area of the DWODC, 2702. The user has a partial view of DCI 2703. When the user selects the scroll bars 2704a,b the user may move the viewable area of the DWODC to a new viewable area 2705. The change of viewable area is communicated by the DWODC client application 2701 to the DWODC service 2706.

FIG. 28b defines the communication process when a user moves the viewable area using the scroll bars. When the viewable area is updated 2801 the DWODC client application sends the viewable area to the DWODC service 2802. The DWODC service receives the viewable area information 2803 and updates the DWODC database 2804.

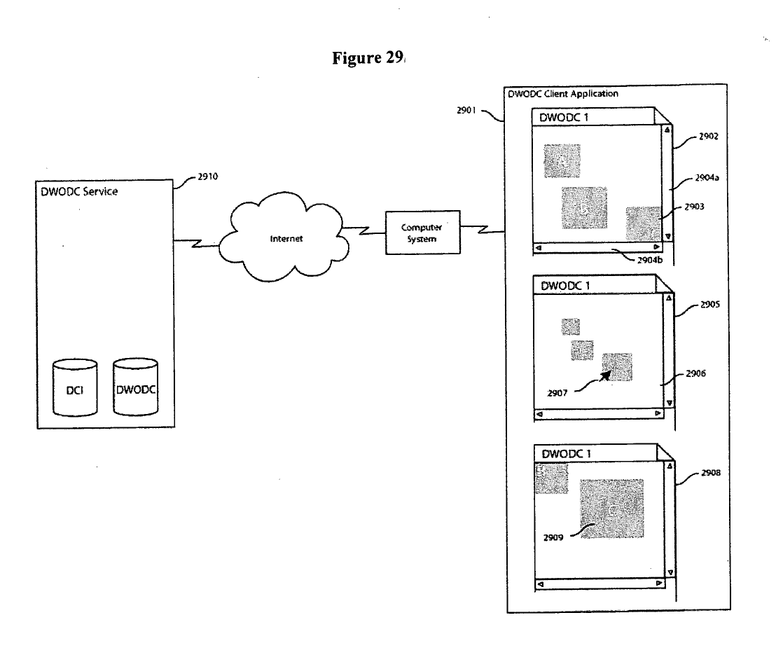

FIG. 29 is an example of navigating a DWODC using a “zoom” interface. When the size of a DOWDC exceeds the size of the window the DWODC client application 2901 only a portion of the DWODC is displayed. The portion displayed is the viewable area of the DWODC. In addition to providing scroll bars 2904a,b the DWODC client application 2901 also provides menu item or a button which provides zoom navigation. When the user selects this menu item or button the DWODC client application 2901 shows a reduced size (zoom) view of the entire workspace. In this view 2905 DCIs are reduced in size so that the entire DWODC can be viewed, for example taking a DCI 2903 not otherwise within the viewable area 2902, and placing the DCI 2907 within the reduced size (zoom) viewable area 2905. The user then selects the portion of the DWODC they want to view at full size 2907 and the DWODC client application shows that portion of the DOWDC at full size 2909 in viewable area 2908. The DWODC client application sends the updated viewable area information to DWODC service 2910.

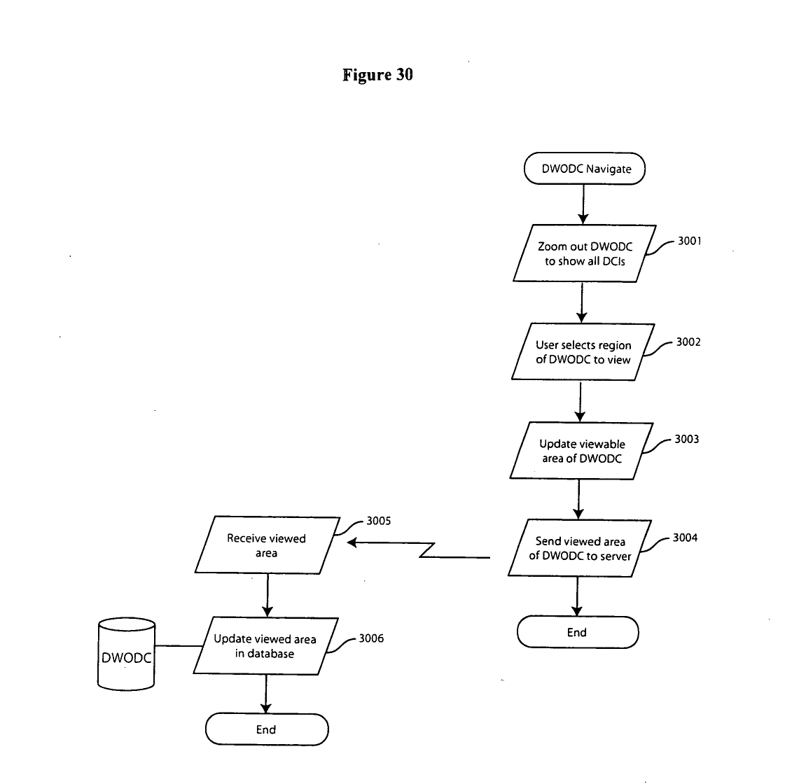

FIG. 30 details the communication process that occurs when a user navigates using the “zoom” interface. When the user selects the zoom menu item or button the DWODC client application displays a reduced size (zoomed) version of the entire DOWDC 3001. The user then selects the region of the DWODC they want to view 3002 and the DWODC client application displays that portion of the DWODC at full size 3003. The DWODC client application then sends the updated viewable area to the DWODC service 3004. When the DWODC service receives the viewable area 3005, the database is updated 3006.

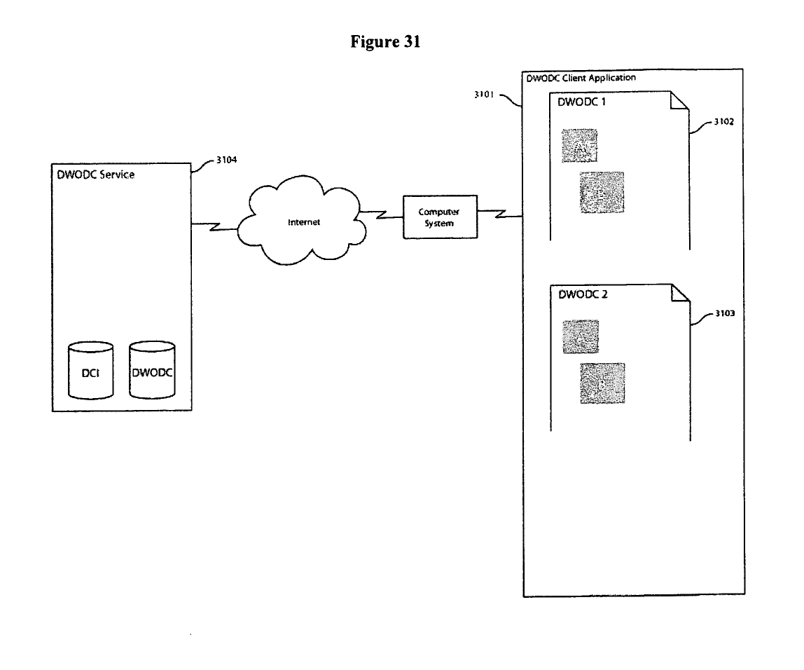

FIG. 31 is an example of copying or duplicating a DWODC. The DWODC client application 3101 provides a menu item or button for copying or duplicating a DWODC. When the user selects the menu item or button, the DWODC client application 3101 creates a copy of the current DWODC 3102 and then makes this newly created DWODC 3103 the current DWODC. The creation of a copy of the current DWODC is communicated by the DWODC client application 3101 to the DWODC service 3104.

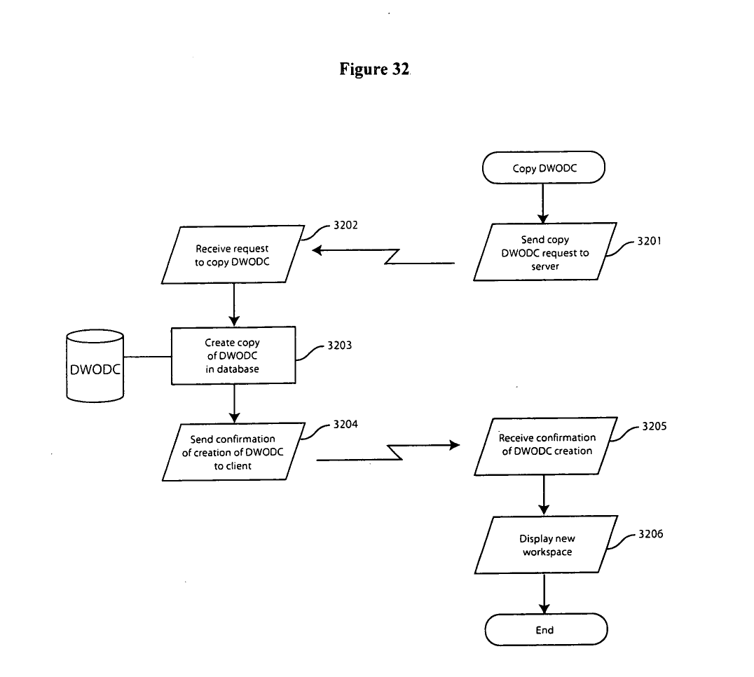

FIG. 32 shows the communication processes which occur when a DWODC is copied or duplicated. When a user copies a DWODC the DWODC client application sends a copy request to the DWODC service 3201. The DWODC service receives this request 3202 and makes a copy of the current DWODC in the database 3203. The DWODC service then sends a confirmation of the duplication 3204 to the DWODC client application. Once the DWODC client application receives confirmation of the 3205 duplication the DWODC client application displays the newly created duplicate workspace 3206.

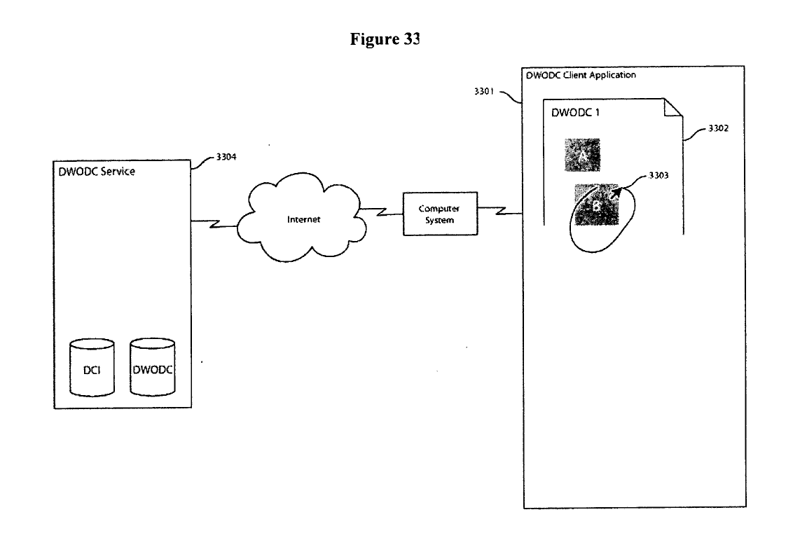

FIG. 33 illustrates the process of adding markup to a DWODC. Markup is simply the process of adding freehand drawing components to the workspace. The DWODC client application 3301 provides the user with a menu item or button which the user can select to begin drawing on the workspace 3302. The markup 3303 is a line or series of lines which the user draws on the workspace. The DWODC client application sends the position, orientation and length of the lines or series of lines to the DWODC service 3304. Alternatively, the DWODC client application may communicate the position and size of pixels, therein representing a line or series of lines, to the DWODC service.

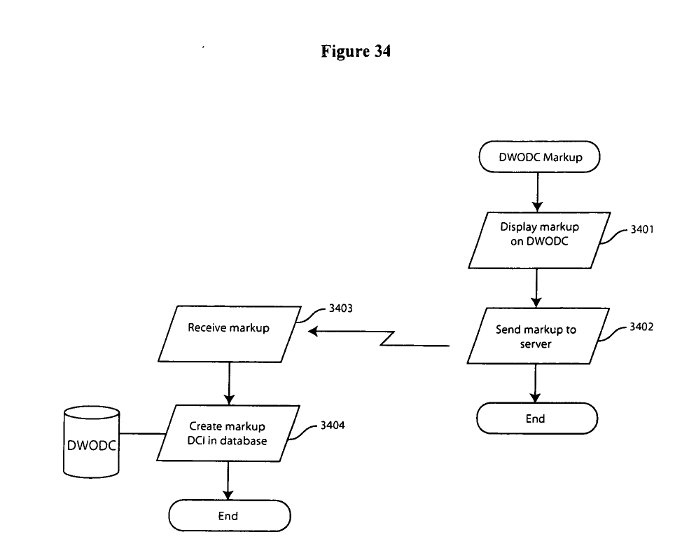

FIG. 34 details the communication process which occurs when a user adds markup to a DWODC. First, the DWODC client application displays the markup on the DWODC 3401, then sends the markup information to the DWODC service 3402. The DWODC service then receives the markup information 3403 and adds the information to the DWODC database 3404.

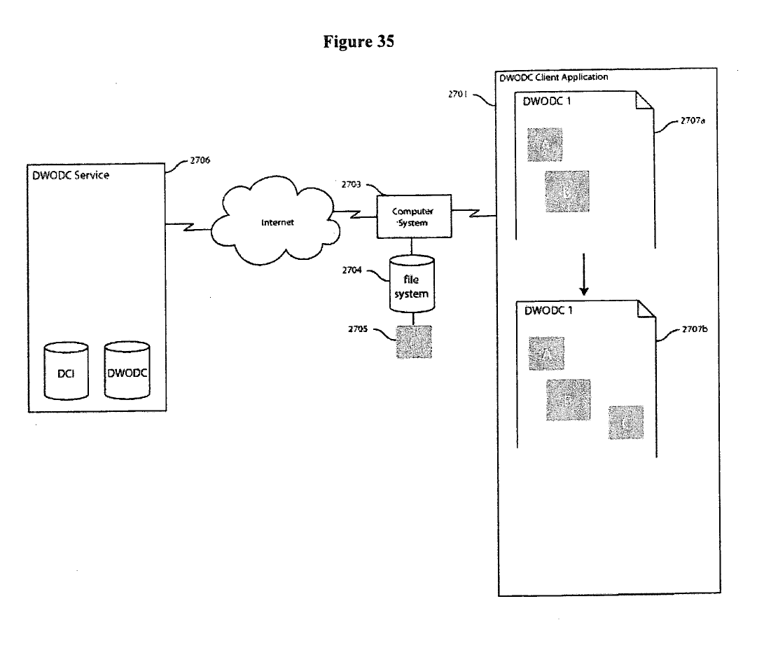

FIG. 35 is an example of uploading new DCIs from the client computer to the DWODC. The DWODC client application 3501 prompts the user to locate the DCI 3505 on the file system 3504 computer 3503 that they want to upload to the DWODC 3507a. The DWODC client application then sends the DCI 3505 to the DWODC service 3506. The DWODC service on the DWODC service then stores the new DCI in the DCI database. The DWODC client application 3501 then displays the new DCI in the DWODC 3507b. It is contemplated that computer 3503 may be the users computer on which the DWODC client application is running, or a separate computer or media storage device, 3508, capable of being accessed by computer 3503; for example through a communications network such as the global Internet or other electronic network (not shown); or alternatively the DWODC service (not shown) for example through a communications network such as the global Internet or other electronic network.

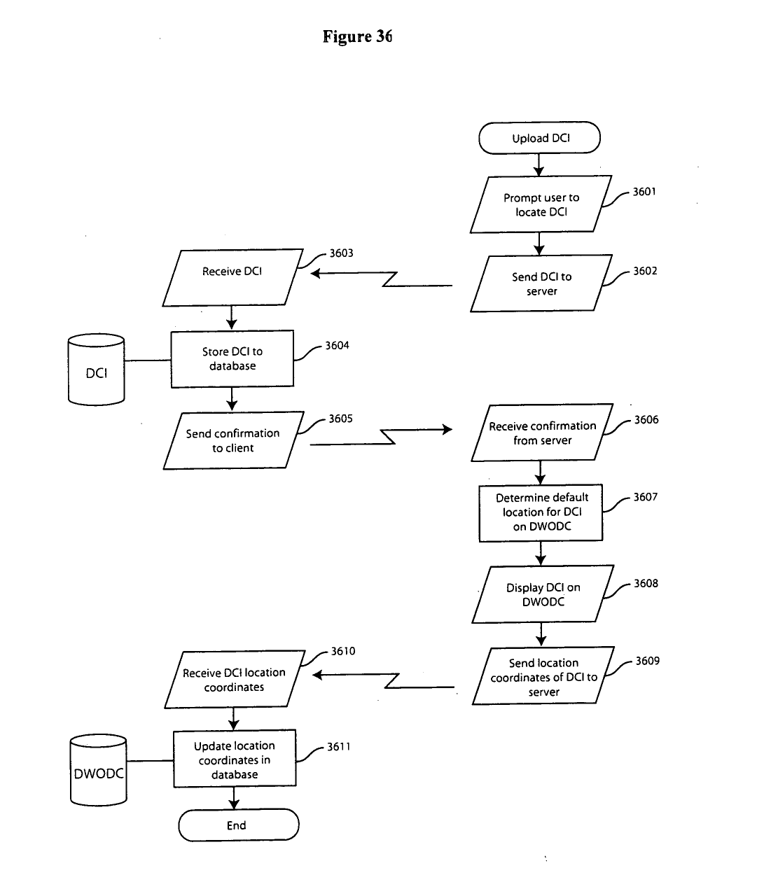

FIG. 36 shows the communication process that occurs when a DCI is uploaded to the DWODC. First, the DWODC client application prompts the user to locate the DCI 3601. The DWODC client application then sends the DCI to the DWODC service 3602. The DWODC service then receives the DCI 3603 and stores the DCI in the database 3604. Then the DWODC service sends a confirmation message to the DWODC client application 3605. When the DWODC client application receives the confirmation message 3606, the DWODC client application determines the default location for the DCI on the current DWDOC 3607. Once the default location has been determined the DWODC client application displays the DCI on the DWODC 3608, and sends the location coordinates of the DCI to the DWODC service 3609. When the DWODC service receives the location coordinates for the DCI 3610, the location coordinates are stored in the DWODC database 3611.

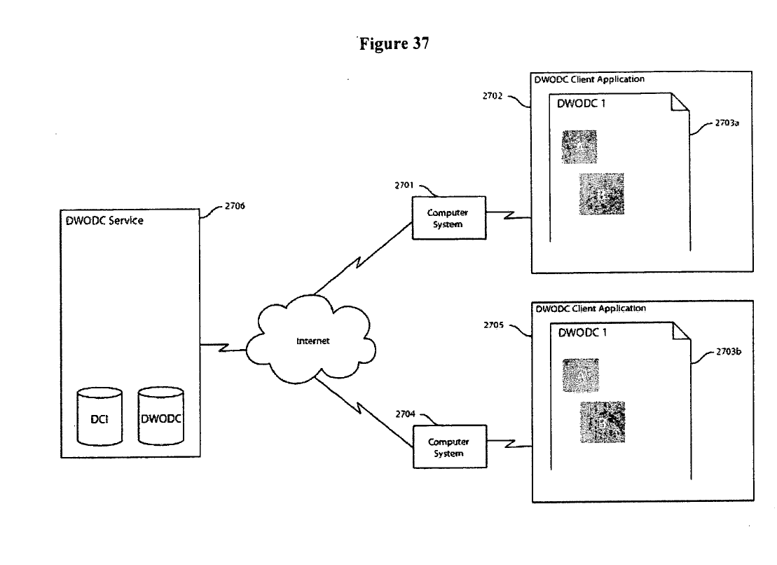

FIG. 37 is an example of two DWODC client applications sharing a single DWODC. In this example, the DWODC 2703a,2703b is being shared by two DWODC client applications 2702,2705 running on two separate computer systems 2701,2704. When one of the DWODC client applications 2702 updates or changes the DWODC 2703a, the changes are then sent to the DWODC service 2707, which then sends the update to the other computer system(s) which are currently sharing the DWODC 2704. The DWODC client application on these machine(s) then updates the DWODC to reflect the changes sent by the DWODC service.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. The invention is therefore to be considered limited solely by the scope of the appended claims.

What is claimed is:

1. A method of purchasing digital content items (DCIs) comprising:
Under the control of a client system;
Importing at least one DCI available for purchase in at least one dynamic workspaces for organizing digital content (DWODC);
Displaying the at least one DWODC,
In response to a request of a purchaser sending a request to purchase at least one DCI contained in the DWODC to a server system;
Wherein the at least one DWODC is capable of displaying at least one manipulation of a DCI, the manipulation selected from the group comprising cropping, resizing, altering the transparency, rotating, scaled cropping, addition of type elements, skewing, flipping, stretching and re-coloring.

2. The method of claim 1 wherein the client system communicates with the server system through a global network.

3. The method of claim 2 wherein the global network is an Internet.

4. The method of claim 1 wherein the DCI is located on the server system.

5. The method of claim 1 wherein the purchaser may request that the DWODC be communicated to a third party.

6. A client system for ordering a DCI comprising:
A display component for displaying at least one DWODC
An import component for introducing at least one DCI into said DWODC
An ordering component capable of initiating a purchase transaction between the client system and a server system
Wherein the DWODC is capable of displaying at least one manipulation of at least one DCI, the manipulation selected from the group comprising cropping, resizing, altering the transparency, rotating, scaled cropping, addition of type elements, skewing, flipping, stretching and re-coloring.

7. The system of claim 6 wherein the client system communicates with the server system through a global network.

8. The system of claim 7 wherein the global network is an Internet.

9. The system of claim 6 wherein the DCI is located on the server system.

10. The system of claim 6 wherein the purchaser may request that the DWODC be communicated to a third party.
